(19) United States
(12) Patent Application Publication
(10) Pub. No.: US 2024/0043951 A1
(43) Pub. Date: Feb. 8, 2024

(54) NON-MAGNETIC TIMEPIECE PARTS AND THERMOMECHANICAL TREATMENT METHOD FOR OBTAINING SAID PARTS

(71) Applicants: UNIVERSITE DE LORRAINE, Nancy (FR); INNOTECH CONSEILS, Maîche (FR)

(72) Inventors: Pascal LAHEURTE, Forbach (FR); Pierre Frédéric CHARBONNIER, Metz (FR); Gael LE COZ, Metz (FR)

(21) Appl. No.: 18/259,011

(22) PCT Filed: Dec. 22, 2021
(86) PCT No.: PCT/EP2021/087307

§ 371 Date: Jun. 22, 2023

(30) Foreign Application Priority Data
Dec. 23, 2020 (FR) 2014031

(51) Int. Cl. C21D 9/00; C22C 38/00; C21D 6/00; C21D 8/00

(52) U.S. Cl. CPC C21D 9/0068; C22C 38/001; C21D 6/00; C21D 8/005; C21D 2211/001

(57) ABSTRACT

A non-magnetic part including an austenitic alloy, the austenitic alloy including between 50 and 85 wt % of iron, one or more gammagene elements the weight percentage or the total weight percentages of which amount to between 15 and 35 wt %, and less than 2 wt % of nitrogen. The austenitic alloy has a crystallographic structure including a predominantly cubic crystal structure and the presence of a hexagonal crystal structure. The magnetic part includes a hardness gradient in the direction extending radially from the surface of the at least one portion of the non-magnetic part to the inside of the non-magnetic part, the hardness gradient having a value greater than or equal to 100 HV.

### TECHNICAL FIELD

The present invention is concerned with a part made of an austenitic alloy, preferably a stainless steel alloy. This alloy can be used to manufacture non-magnetic parts. This alloy is appropriate, in particular, for the manufacture of non-magnetic parts of revolution comprising a mechanical axis. The present invention is also concerned with a thermomechanical treatment method for the implementation of such non-magnetic parts comprised of such an alloy. The present invention relates to, for example, precision timepieces and in particular, but not exclusively, balance wheels or balance staffs, pallet staffs or even escape pinions.

### STATE OF PRIOR ART

It is known from the state of the art that precision timepieces, and in particular the balance wheel, should have good resistance to impact, fracture, deformation and wear. The balance wheel is one of the most important precision timepieces as it is the regulating member. The balance wheel moves back and forth regularly by oscillating about its axis. The balance axis supports the spiral spring and comprises a pivot at each of its two ends.

In the state of prior art, precision timepieces, in particular balance staffs, made of steel, for example 20AP and FINEMAC type steels are known. A first drawback is that 20AP steel contains lead, which is a toxic element that should be banned. Another drawback is that these steels are likely to have residual magnetisation or remanence after being subjected to external magnetic fields. This residual magnetisation disturbs the operation of the parts of regulating members.

In the state of prior art, methods are known for manufacturing precision timepieces in order to shape the parts and improve their resistance to impact, fracture and wear. In particular, methods for manufacturing precision timepieces from 20AP and FINEMAC type steel are known. One drawback of these methods is that they require the implementation of a quenching step followed by tempering to relieve mechanical stresses generated in the material during quenching.

Another drawback lies in the fact that the use of a mechanical hardening treatment on some stainless steels of the state of the art results in the appearance of residual magnetisation in the parts manufactured.

Another drawback is that the thermomechanical hardening methods of the state of the art make the parts manufactured more brittle and therefore more likely to break during use.

One purpose of the invention is especially:
to provide a method, an alloy and a non-magnetic part comprised of such an alloy making it possible to overcome, at least in part, drawbacks of the state of the art, and/or
to provide a method for obtaining parts in which at least one surface has a centre line average roughness of less than 0.05 μm, and/or
to provide a method for obtaining a part in which at least one portion of the surface has a hardness greater than 700 HV, and/or
to provide a method for obtaining a non-magnetic part, and/or
to provide a non-magnetic part,
to provide a non-magnetic part with improved resistance to impact, fracture, deformation and wear, and/or
to provide a non-magnetic part with good resistance to fracture, for example an elongation at break greater than 1.5%, and/or
to provide a method which does not include a tempering step for adjusting the hardness and relaxing mechanical stresses in the material constituting the manufactured part, and/or
to provide a method for obtaining a part at least one portion of which has a maximum strength greater than 2200 MPa.

### DISCLOSURE OF THE INVENTION

For this purpose, an austenitic alloy is provided comprising, as a weight percentage, iron of between 50 and 85%, one or more gammagenic elements whose weight percentage or the sum of the weight percentages is between 8 and 38% and nitrogen at a weight percentage of less than 2%;
said austenitic alloy has a crystallographic structure comprising a majority cubic, preferably face-centred cubic, crystal structure, and a presence of a hexagonal, preferably hexagonal compact, crystal structure and/or a presence of nitrogen atoms bordering or surrounding or wrapping or situated around dislocations of the alloy, preferably around dislocations of the alloy.

Nitrogen atoms have the effect of blocking movement of said dislocations in the alloy and therefore increasing hardness of the alloy.

The term “crystal structure” may be taken to mean “grains having a crystal structure”.

Preferably, the austenitic alloy does not contain nickel.

Preferably, the alloy comprises a weight percentage of nitrogen of less than 1.9%, still more preferably 1.8%, still more preferably 1.7%, still more preferably 1.6%, still more preferably 1.5%, especially preferably 1.4%, most preferably 1.3%.

Preferably, the alloy comprises precipitates, or crystal precipitates, with a hexagonal, preferably hexagonal close-packed, crystallographic structure.

Preferably, the presence of hexagonal, preferably hexagonal close-packed, crystal structure is included in, preferably constituted by, the precipitates.

Preferably, a Feret diameter of the precipitates is between 5 and 80 nm.

The austenitic alloy may comprise nitrogen in a weight percentage greater than 0.1%, preferably greater than 0.3%.

The gammagenic element(s) may comprise, in weight percentage, manganese between 8 and 30% and/or cobalt between 0 and 10%, preferably between 0 and 5% cobalt, and/or carbon between 0.1 and 0.3%.

The alloy may comprise one or more non-gammagenic elements whose weight percentage or the sum of the weight percentages is between 8 and 35% or between 10 and 35%, preferably between 13 and 35%, still more preferably between 15 and 35%, more preferably between 17 and 33%, even more preferably between 19 and 31% and most preferably between 20 and 30%.

Preferably, the weight percentage or the sum of the weight percentages of the non-gammagenic element(s) is less than 30%.

Preferably, the weight percentage or the sum of the weight percentages of the gammagenic element(s) is greater than 8%, preferably 15%. Preferably, the weight percentage or the sum of the weight percentages of the gammagenic element(s) is between 15 and 38%.

The non-gammagenic element(s) may comprise, in weight percentage, chromium between 0 and 35% and/or molybdenum between 0 and 8% and/or silicon between 0 and 2% and/or titanium between 0 and 1% and/or niobium between 0 and 1% and/or tungsten between 0 and 1% and/or sulphur between and 1.5%.

Preferably, the non-gammagenic element(s) comprise(s), in weight percentage, chromium between 8 and 35%, more preferably between 10 and 35%, further preferably between 12 and 35%, more preferably between 15 and 35%, still more preferably between 17 and 33%, particularly advantageously between 19 and 31% and most preferably between 20 and 30%.

Preferably, the austenitic alloy comprises chromium in a weight percentage greater than 8%.

Preferably, the austenitic alloy comprises chromium, in weight percentage, between 8 and 35%, preferably between 10 and 35%, preferably between 12 and 35%, more preferably between 15 and 35%, still more preferably between 17 and 33%, particularly advantageously between 19 and 31% and most preferably between 20 and 30%.

Preferably, the alloy comprises a cold worked austenitic phase, denoted γ_{cold worked}, the lattice parameter of which is preferably 0.3635 nm, and a non-cold worked austenitic phase, denoted γ_{non-cold worked}, the lattice parameter of which is preferably 0.360 nm.

Preferably, the alloy according to the invention does not comprise martensite. Preferably, the alloy according to the invention does not comprise ferrite.

The alloy according to the invention may comprise a reformed, or undeformed, austenitic phase, the lattice parameter of which is preferably nm, and a deformed austenitic phase, the lattice parameter of which is preferably 0.3632 nm.

Preferably, the alloy comprises the reformed or undeformed austenitic phase. Preferably, the cold worked alloy does not comprise a deformed austenitic phase.

Preferably, the reformed austenitic phase is located on the dislocations or on the slip bands.

Preferably, the reformed austenitic phase is located at the grain boundaries.

Preferably, the alloy comprises nitride precipitates. Preferably, the nitride precipitates contribute to immobilising dislocations. Preferably, the nitride precipitates contribute to increasing hardness of the alloy.

Preferably, the nitride precipitates are intra and/or inter granular, that is located in the grains and/or in the grain boundaries. Preferably, and in particular, the nitride precipitates are located at the dislocations, preferably at the slip bands.

Preferably, the nitride precipitates are uniformly distributed within the alloy.

Preferably, a size of the nitride precipitates is less than 300 nm, preferably less than 250 nm, further preferably less than 200 nm, more preferably less than 150 nm and still more preferably less than 100 nm. Preferably, the size of the nitride precipitates in the alloy and/or the uniform distribution of the nitride precipitates in the alloy has the effect of increasing hardness of the alloy.

Preferably, the nitride precipitates comprise chromium nitrides, further preferably chromium heminitrides Cr₂N.

Preferably, the alloy comprises an austenitic phase having a nitrogen concentration of less than or equal to 0.6%, preferably 0.5%, still preferably 0.4% and more preferably 0.3%.

Preferably, the alloy comprises an austenitic phase having a nitrogen concentration greater than or equal to 0.7%, preferably 0.8%, still more preferably 0.9%, more preferably 1% and most preferably 1.1%.

Preferably, the austenitic phase having a nitrogen concentration of less than or equal to 0.6%, preferably 0.5%, still preferably 0.4% and more preferably 0.3% is the reformed austenitic phase.

Preferably, the austenitic phase having a nitrogen concentration greater than or equal to 0.7%, preferably 0.8%, still preferably 0.9%, more preferably 1% and most preferably 1.1% is the deformed austenitic phase.

Preferably, the reformed austenitic phase comprises a superstructure. The term “superstructure” may be taken to mean an ordered crystal structure obtained by the effect of temperature, preferably by heating, on a disordered structure.

Preferably, the reformed austenitic phase comprises a disordered phase, noted γ′, and a phase including a superstructure, noted γ″. Preferably the phase γ′ does not comprise a superstructure. Preferably, the phase γ′ is a minority phase within the reformed austenitic phase. Preferably, the phase γ″ is a majority phase within the reformed austenitic phase.

Preferably, the superstructure contributes to immobilising dislocations. Preferably, the superstructure contributes to increasing hardness of the alloy.

Preferably, a ratio between the deformed austenitic phase and the reformed austenitic phase is greater than 25%, preferably 35%, still preferably 45% and more preferably 50%.

Preferably, a ratio of the deformed austenitic phase to the reformed austenitic phase is greater than 60%, preferably 70%, still preferably 80% and more preferably 90%.

Preferably, a grain size of the alloy is less than 5 μm, still preferably less than 1 μm.

Further preferably, the grain size of the alloy is less than 900 nm, still preferably less than 800 nm, more preferably less than 700 nm, still more preferably less than 600 nm and most preferably less than 500 nm. “Alloy grain size” may be taken to mean the size of each of the grains making up the alloy. Such a grain size of the alloy according to the invention has the effect of increasing hardness of the alloy.

A non-magnetic part is also provided, comprising, preferably made of or comprised of, an austenitic alloy according to the invention.

Preferably, the non-magnetic part is a mechanical part.

The non-magnetic part may be a part of revolution.

The non-magnetic part may be oblong, conical, frustoconical or cylindrical in shape.

At least one portion of a surface of the non-magnetic part may have a hardness greater than or equal to 700 HV, where HV is Vickers hardness.

The surface of the non-magnetic part may be an outer surface of the magnetic part.

Preferably, the centre line average roughness of the at least one portion of the surface of the non-magnetic part corresponding to the at least one portion of the surface of the cold worked and smoothed mechanical part is less than 0.4 μm, further preferably less than 0.3 μm, more preferably less than 0.2 μm, still more preferably less than 0.1 μm, particularly advantageously less than 0.05 μm and most preferably less than 0.025 μm.

The non-magnetic part may comprise a surface layer.

The non-magnetic part may comprise a surface layer radially extending, from at least one portion of the surface inwardly of the non-magnetic part, over a distance, referred to as the thickness of the surface layer, of less than 30 μm.

Inwardly of the non-magnetic part may be taken to mean towards a centre, a centre of symmetry or an axis of symmetry of the mechanical part.

The thickness of the surface layer can be defined as the dimension or magnitude of the surface layer in the direction radially extending from the at least one portion of the surface of the non-magnetic part inwardly of the non-magnetic part.

Preferably, the thickness of the surface layer is less than 25 μm, further preferably less than 20 μm, preferably less than 15 μm, still preferably less than 10 μm, more preferably less than 8 μm, still more preferably less than 7 μm, particularly advantageously less than 6 μm and most preferably less than 5 μm.

The non-magnetic part may comprise a central portion extending from the surface layer inwardly of the non-magnetic part, said central portion having a hardness less than or equal to 600 HV and/or a cold working rate less than 85%.

Preferably, the central portion may extend from an interface or surface separating the surface layer from the central portion inwardly of the non-magnetic part.

The surface layer may comprise a hardness gradient, and/or respectively a cold working rate gradient, along the direction radially extending from the surface of the at least one portion of the non-magnetic part inwardly of the non-magnetic part, said hardness gradient having a value greater than or equal to 100 HV and/or respectively said cold working rate gradient having a value greater than 14%.

By “hardness gradient having a value greater than or equal to 100 HV”, it is meant a variation in hardness between the surface of the at least one portion of the non-magnetic part and the central portion greater than or equal to 100 HV or a difference between the hardness of the surface of the at least one portion of the non-magnetic part and the hardness of the central portion which is greater than or equal to 100 HV. By analogy, “a cold working rate gradient with a value greater than 14%” is taken to mean a variation in cold working rate between the surface of the at least one portion of the non-magnetic part and the central portion which is greater than or equal to 14% or a difference between the cold working rate of the surface of the at least one portion of the non-magnetic part and the cold working rate of the central portion which is greater than or equal to 14%.

Preferably, the hardness gradient of the surface layer is greater than 125 HV, further preferably than 150 HV, preferably than 175 HV, more preferably than 200 HV, still more preferably than 225 HV and most preferably 250 HV and/or the cold working rate of the surface
layer is greater than 18%, further preferably 21%, preferably 25%, more preferably 29%, still more preferably 32% and most preferably 35%.

Preferably, the hardness and/or cold working rate of the surface layer decreases along the direction extending from the surface of the non-magnetic part inwardly of the non-magnetic part.

Preferably, the at least one portion of the surface of the non-magnetic part constitutes a portion of revolution of the non-magnetic part.

Preferably, the surface of the at least one portion of the surface of the non-magnetic part is a surface of revolution.

Preferably, the at least one portion of the surface of the non-magnetic part is a surface defining or delimiting a friction zone of the non-magnetic part.

Preferably, the at least one portion of the surface of the non-magnetic part comprises or constitutes an end, a peak, an apex or, preferably, a pivot or a pivot zone of the non-magnetic part.

Non-magnetic may be taken to mean a material whose relative permeability is less than 10, preferably 7, further preferably 5, preferably 4, still more preferably 3, more preferably 2, still more preferably 1.1, particularly advantageously 1.05 and most preferably 1.01.

Preferably, a hardness, and/or respectively the cold working rate, of the at least one portion of the surface of the non-magnetic part, corresponding to the at least one portion of the cold worked and heated mechanical part, is greater than or equal to 700 HV, preferably 750 HV, still more preferably 800 HV, preferably 850 HV, more preferably 900 HV, still more preferably 950 HV and most preferably 1000 HV where HV is the Vickers hardness and/or respectively is greater than 100%, preferably 107%, still preferably 114%, preferably 121%, more preferably 128%, still more preferably 135% and most preferably 142%.

Preferably, a maximum strength of the non-magnetic part is greater than 2200 MPa, still more preferably greater than 2500 MPa.

Preferably, an elongation at break of the non-magnetic part is greater than 1.5%, preferably greater than 2.5%.

Preferably, the at least one portion of the surface of the non-magnetic part corresponding to the at least one portion of the surface of the cold worked and heated mechanical part may comprise a friction zone of the non-magnetic part or a portion of a mechanical axis of the non-magnetic part.

Preferably, the at least one portion of the surface of the non-magnetic part corresponding to the at least one portion of the surface of the at least one portion of the cold worked and heated mechanical part may comprise a friction zone of a mechanical axis of the non-magnetic part.

Preferably, the at least one portion of the surface of the non-magnetic part corresponding to the at least one portion of the surface of the cold worked and heated mechanical part may comprise a pivot of the mechanical axis of the non-magnetic part.

The at least one portion of the surface of the non-magnetic part corresponding to the at least one portion of the surface of the cold worked and heated mechanical part may be an external surface defining or delimiting the entire mechanical axis and/or an end portion of the mechanical axis and/or may comprise an external surface defining or delimiting pivot of the mechanical axis.

A diameter, for example maximum or average diameter, of the portion of the non-magnetic part comprising the at least one portion of the surface of the non-magnetic part corresponding to the at least one portion of the surface of the cold worked and heated mechanical part may be less than 2 mm, preferably less than 1 mm.

Preferably, the diameter of the portion of the non-magnetic part comprising the at least one portion of the surface of the non-magnetic part corresponding to the at least one portion of the surface of the cold worked and heated mechanical part is less than 0.9 mm, still preferably less than 0.8 mm, still more preferably less than 0.7 mm, still more preferably less than 0.6 mm and most preferably less than 0.5 mm.

Still preferably, the diameter of the portion of the non-magnetic part comprising the at least one portion of the surface of the non-magnetic part corresponding to the at least one portion of the surface of the cold worked and heated mechanical part is less than 0.4 mm, more preferably less than 0.3 mm, still more preferably less than 0.2 mm and most preferably less than 0.1 mm.

A diameter of the pivot of the mechanical axis may be less than 0.1 mm, further preferably less than 0.08 mm, more preferably less than 0.06 mm, still more preferably less than 0.04 mm and most preferably less than 0.03 mm.

Preferably, the non-magnetic part is a precision timepiece.

Preferably, the precision timepiece is a balance wheel or balance staff, a pallet staff or an escape pinion.

According to the invention, a use of the non-magnetic part according to the invention is also provided, for its non-magnetic and/or hardness and/or tribological and/or fracture resistance and/or resilience properties.

According to the invention, a use of the non-magnetic part as a mechanical part or as a precision timepiece is also provided.

According to the invention, a method for manufacturing a non-magnetic part is also provided, said method comprising, or consisting of:
a step of obtaining a mechanical part, at least one portion of a surface of the mechanical part having a hardness greater than 350 HV, where HV is the Vickers hardness, and/or a cold working rate greater than 50%, then
a surface cold working step to form a surface layer radially extending from at least one portion of the surface of the mechanical part inwardly of the mechanical part, and then
a step of heating the mechanical part or a portion of the mechanical part comprising the at least one portion of the surface of the part or the at least one portion of the surface of the cold worked mechanical part to a temperature of between 350° C. and 700° C. to harden the cold worked portion or portions of the mechanical part.

Preferably, the hardened portion or portions comprise the at least one portion of the surface of the mechanical part.

The hardened, that is cold worked and heated, portion or portions of the mechanical part may comprise one or more cold worked portions prior to implementing the method.

Preferably, the method does not comprise a step implemented subsequently to the heating step.

By “cold worked mechanical part”, it is meant the mechanical part obtained after implementing the surface cold working step.

Preferably, the surface cold working step is implementing by machining at least one portion of the surface of the mechanical part.

Surface cold working can also be carried out by roll bending. Preferably, a machining step can be carried out prior to the roll bending step.

Preferably, the surface cold working step, and therefore the machining used to implement the surface cold working step, is not intended to remove or withdraw material from the mechanical part from the at least one portion of the surface of the mechanical part.

Preferably, the surface cold working step, and therefore the machining used to implement the surface cold working step, does not remove or withdraw material from the mechanical part from at least one portion of the surface of the mechanical part.

Machining can be turning.

Machining can be bar turning.

According to the invention, turning may be taken to mean a method consisting of machining a part on a lathe.

Preferably, the method does not comprise quenching the mechanical part.

Preferably, the method does not comprise stress relief annealing for the relaxation of mechanical stresses.

Those skilled in the art will understand stress relief annealing to mean a heating step to a temperature below 350° C. Those skilled in the art knows that the purpose of stress relief annealing is to eliminate residual stresses accumulated upon manufacturing the part.

Preferably, the heating step is implemented on the mechanical part as a whole.

The obtaining step may consist in providing the mechanical part.

Preferably, the surface of the mechanical part is an outer surface of the mechanical part.

The mechanical part may be a part of revolution.

The mechanical part may be oblong, conical, frustoconical or cylindrical in shape.

The at least one portion of the surface of the mechanical part may constitute a portion of revolution of the mechanical part.

The at least one portion of the surface of the mechanical part may be a surface of revolution.

According to the invention, the cold working rate may be taken to mean a relative variation in length and/or cross-section, in the plastic deformation zone, of an object. According to the invention, the relative variation can be defined with respect to an initial state of the object, here the mechanical part, in which it is not cold worked.

Preferably, during the heating step, the at least one portion of the surface of the cold worked mechanical part or the mechanical part as a whole is heated to a temperature of between 350° C. and 700° C., further preferably between 400° C. and 680° C., more preferably between 450° C. and 650° C. and still more preferably between 500° C. and 600° C.

Preferably, during the heating step, the at least one portion of the surface of the cold worked mechanical part or the mechanical part as a whole is heated to a temperature above 350° C., further preferably 400° C., more preferably 450° C. and still more preferably 500° C. and to a temperature below 700° C., still preferably 680° C., still preferably 650° C. and still more preferably 600° C.

Preferably, the mechanical part is comprised of an austenitic alloy comprising iron between 50 and 85%, one or more gammagenic elements whose weight percentage or the sum of the weight percentages is between 8 and 38% and nitrogen at a weight percentage of less than 2%, preferably a weight percentage of nitrogen greater than 0.1%.

More preferably, the chemical element composition of the mechanical part is identical to that of the austenitic alloy according to the invention.

Preferably, the austenitic alloy does not contain nickel.

Preferably, the surface cold working step induces surface cold working of the part of the mechanical part comprising the at least one portion of the surface of the mechanical part.

Preferably, the cold working rate of the at least one portion of the surface of the non-magnetic part corresponding to the at least one portion of the surface of the cold worked mechanical part, obtained by implementing the surface cold working step, is greater than 100%, preferably 107%, further preferably 114%, preferably 121%, more preferably 128%, still more preferably 135% and most preferably 142%.

The surface layer, after heating, may have a hardness gradient, along the direction radially extending from the surface of the at least one portion of the non-magnetic part inwardly of the non-magnetic part, having a value greater than or equal to 100 HV.

The at least one portion of the surface of the non-magnetic part corresponding to the at least one portion of the surface of the cold worked and heated mechanical part may have a hardness greater than or equal to 700 HV.

Preferably, the surface layer has a cold working rate gradient, along the direction radially extending from the surface of the at least one portion of the cold worked mechanical part inwardly of the cold worked mechanical part, greater than 14 or 18%, further preferably 21%, preferably 25%, more preferably 29%, still more preferably 32% and most preferably 35%.

A cold working depth, relative to the at least one portion of the surface of the cold worked mechanical part, obtained by implementing the surface cold working step, may be less than 30 μm, preferably less than 25 μm, further preferably less than 20 μm, preferably less than 15 μm, further more preferably less than 10 μm, more preferably less than 8 μm, still more preferably less than 7 μm, particularly advantageously less than 6 μm and most preferably less than μm.

Preferably, the cold working depth corresponds to or is equal to the thickness of the surface layer of the non-magnetic part.

Upon reading the application, it appears directly and unambiguously that the step of heating the at least one portion of the surface of the mechanical part is preferably carried out directly after the step of surface cold working the mechanical part.

Upon reading the application, it appears directly and unambiguously that, preferably, the method does not comprise heating, preferably a step of heating the surface layer of the non-magnetic part, formed during the surface cold working step, to a temperature above 700° C., preferably 680° C., further preferably 650° C., more preferably 600° C.

The heating step:
may be carried out for a duration of between 10 minutes and 400 hours, preferably between 20 minutes and 4 hours, further preferably between 30 minutes and 2 hours, more preferably for a duration of 1 hour, and/or
may comprise a temperature gradient of between 4° C./min and 400° C./min, preferably a gradient of 50° C./min, and/or
may be implemented under ambient conditions or under a controlled atmosphere.

Preferably, the temperature gradient is implemented during the rise and/or during the fall in temperature.

Preferably the controlled atmosphere can be a neutral atmosphere. The neutral atmosphere may be an atmosphere containing no reactive species, for example no oxidising or corrosive species. The controlled atmosphere can be a nitrogen or a rare gas, for example argon.

According to a first alternative, the step of obtaining the mechanical part may comprise a step of bar turning at least one portion of a turning bar to form the mechanical part, at least one portion of a surface of the mechanical part having a hardness greater than 350 HV, where HV is the Vickers hardness, and/or a cold working rate greater than 50%.

According to a second alternative, the step of obtaining the mechanical part may comprise a step of cold working at least one portion of a raw bar to form the mechanical part, at least one portion of a surface of the mechanical part having a hardness greater than 350 HV, where HV is the Vickers hardness, and/or a cold working rate greater than 50%.

According to the second alternative, the raw bar can be:
a non-cold worked bar, in other words an annealed bar, or
a cold worked bar, or
a bar turned according to the first alternative or not.

According to a third alternative, the step of obtaining the mechanical part may comprise a step of bar turning of at least one portion of a turning bar followed by a step of cold working of the at least one turned part of the turning bar, or of the turning bar as a whole, to form the mechanical part with at least one portion of a surface of the mechanical part having a hardness greater than 350 HV, where HV is the Vickers hardness, and/or a cold working rate greater than 50%.

According to a fourth alternative, the step of obtaining the mechanical part may comprise a step of cold working at least one portion of a raw bar, or the raw bar as a whole, followed by a step of bar turning at least one portion of the cold worked raw bar to form the mechanical part with at least one portion of a surface of the mechanical part having a hardness greater than 350 HV, where HV is Vickers hardness, and/or a cold working rate greater than 50%.

According to the fourth alternative, the raw bar can be:
a non-cold worked bar, in other words an annealed bar, or
a cold worked bar.

According to the second and/or fourth alternative, the at least one portion of the raw bar, before cold working, comprises a surface preferably having a hardness greater than or equal to 250 HV, preferably 280 HV and/or a cold working rate greater than or equal to 0%, further preferably equal to 0%. According to the second and/or fourth alternative, the at least one portion of the raw bar, before cold working, comprises a surface preferably having a hardness between 250 and 300 HV and/or a cold working rate equal to 0%.

According to the second and/or fourth alternative, the obtaining step may comprise a step consisting in providing the raw bar at least one portion of which comprises a surface having a hardness greater than or equal to 250 HV, preferably 280 HV and/or a cold working rate greater than or equal to 0%, further preferably equal to 0. According to the second and/or fourth alternative, the obtaining step may comprise a step consisting in providing the raw bar at least one portion of which comprises a surface having a hardness of between 250 and 300 HV and/or a cold working rate equal to 0%.

According to the second and/or third and/or fourth alternative, the at least one portion of the raw bar, before cold working, can comprise a surface preferably having a hardness greater than or equal to 350 HV, preferably 400 HV and/or a cold working rate greater than or equal to 20%, still more preferably greater than 30%. According to the second and/or third and/or fourth alternative, the at least one portion of the raw bar, before cold working, can comprise a surface preferably having a hardness of between 350 HV and 400 HV and/or a cold working rate of between 20% and 30%.

According to the second and/or third and/or fourth alternative, the obtaining step may comprise a step consisting in providing the raw bar, at least one portion of which comprises a surface having a hardness greater than or equal to 350 HV, preferably 400 HV and/or a cold working rate greater than or equal to 20%, still more preferably greater than 30%. According to the second and/or third and/or fourth alternative, the obtaining step may comprise a step consisting in providing the raw bar, at least one portion of which comprises a surface having a hardness of between 350 HV and 400 HV and/or a cold working rate of between 20% and 30%.

According to the first and/or fourth alternative, the at least one portion of the turning bar, before bar turning, preferably has a hardness greater than or equal to 325 HV, further preferably 350 HV, preferably 375 HV and more preferably 400 HV and/or a cold working rate greater than or equal to 15%, further preferably 20%, further preferably 25% and more preferably 30%. According to the first and/or fourth alternative, at least one portion of the turning bar, before bar turning, preferably has a hardness of between 350 and 400 HV and/or a cold working rate of between 20 and 30%.

According to the first and/or fourth alternative, the obtaining step may comprise a step consisting in providing a turning bar, at least one portion of which has a hardness greater than or equal to 325 HV, preferably 350 HV, further preferably 375 HV and more preferably 400 HV, and/or a cold working rate greater than or equal to 15%, further preferably 20%, more preferably 25% and more preferably 30%. According to the first and/or fourth alternative, the obtaining step may comprise a step consisting in providing the turning bar, at least one portion of which has a hardness of between 350 and 400 HV and/or a cold working rate of between and 30%.

According to the first, second, third and/or fourth alternative, the turning bar is preferably a diameter calibrated bar. According to the first, second, third and/or fourth alternative, the turning bar is preferably a diameter calibrated cold worked bar, preferably cold worked by drawing.

According to one of the first, second, third or fourth alternatives:
the turning bar and/or the turned bar and/or the raw bar and/or the cold worked raw bar may be a bar of revolution, and/or
the turning bar and/or the turned bar and/or the raw bar and/or the cold worked raw bar may be oblong in shape; and/or
the turning bar and/or the turned bar and/or the raw bar and/or the cold worked raw bar may have a cylindrical shape, such as a rod or a tube, and/or
the at least one portion of the turning bar may be the entire turning bar and/or the at least one portion of the raw bar may be the entire raw bar, and/or
the bar turning step may comprise forming a surface of revolution, on the turning bar, defining or delimiting a portion of the turning bar, and/or
the bar turning step may comprise modifying the shape of at the least one portion of the turning bar, and/or
the bar turning step may comprise reducing a diameter of the at least one portion of the turning bar, and/or
decreasing the diameter of the at least one portion of the turning bar may comprise varying the diameter along the at least one portion of the turning bar, and/or
the turning bar, prior to bar turning, and/or the raw bar, prior to bar turning, and/or the cold worked raw bar, prior to bar turning, preferably has a hardness of less than 60%, more preferably 50%.

Preferably, the bar turning step is a machining step. Preferably, the purpose of the bar turning step is to remove or withdraw material from the at least one portion of the turning bar and/or the raw bar and/or the cold worked raw bar.

The cold working step implemented during the step of obtaining the mechanical part and the surface cold working step are two distinct steps.

Preferably, the cold working step and/or the surface cold working step according to the invention is carried out while cold, that is at a temperature below 50° C., further preferably below 30° C., more preferably at ambient temperature or at standard temperature.

Preferably, the cold working step increases the cold working rate of at least one portion of the bar and/or the turned bar and/or the raw bar by at least 10%, more preferably by at least 15% and most preferably by at least 20%. In other words, a difference between the at least one portion of the turning bar and/or the turned bar and/or the raw bar, before cold working, and the at least one portion of the cold worked turning bar and/or the cold worked turned bar and/or the cold worked raw bar, after cold working, is preferably greater than 10%, further preferably greater than 15% and preferably greater than 20%.

Preferably, the step of cold working the at least one portion of the raw bar or the at least one portion of the turning bar or the at least one turned portion of the turning bar is a drawing step to decrease a diameter of the at least one portion of the raw bar or the at least one portion of the turning bar or the at least one turned portion of the turning bar.

Preferably, the method comprises a smoothing step to decrease roughness of the at least one portion of the surface of the mechanical part.

The smoothing step may comprise modifying the shape of the at least one portion of the surface of the mechanical part.

The smoothing step may be a turning step.

The smoothing step may be implemented on all or part, for example on at least one portion of the surface of the mechanical part, of the mechanical part.

Preferably, the smoothing step is not intended to significantly decrease the diameter of at least one portion of the surface of the mechanical part. Preferably, the smoothing step does not significantly decrease the diameter of the at least one portion of the surface of the mechanical part.

Although the purpose of the smoothing step is not to remove material, the smoothing step is considered to be machining according to the invention.

Preferably, the smoothing step and the surface cold working step are implemented simultaneously in a same and/or single step.

The smoothing step and the surface cold working step can be implemented simultaneously during the same turning step.

The turning step can be a roll bending or roller burnishing step.

The turning step can be carried out on the whole of the mechanical part or on at least one portion of the surface of the mechanical part.

The surface cold working step and the smoothing step may constitute a same and/or single roll bending or roller burnishing step.

Preferably, the part of revolution and/or the precision timepiece and/or the non-magnetic part and/or the mechanical part and/or the at least one portion of the surface of the non-magnetic part corresponding to the at least one portion of the surface of the cold worked and heated mechanical part and/or the turning bar and/or the raw bar has a composition of chemical elements identical to that of the austenitic alloy according to the invention.

Preferably, the method and the implementation conditions have the following effects:
generating a transformation of the crystal structure of the alloy making up the mechanical part resulting in the appearance of a crystal structure resulting in the appearance of a hexagonal, preferably hexagonal close-packed, crystal structure, and/or
generating the appearance of precipitates with a hexagonal, preferably hexagonal close-packed, crystal structure, and/or
causing a migration of nitrogen atoms, in particular interstitial nitrogen atoms present in the crystal lattice of the alloy making up the mechanical part, at the edge or at the edge of dislocations of said alloy, and/or
generating the appearance of precipitates with a hexagonal close-packed crystal structure, by segregation of solute atoms, in particular nitrogen atoms, into stacking defects in the face-centred cubic crystal structure of the cold worked alloy, and/or
generating a surface layer having a hardness gradient.

An amount of reformed, or undeformed, austenitic phase in the part preferably depends on the duration of the heating step.

Preferably, a cold working rate greater than or equal to 30% is preferable in order to make appear the superstructure within the reformed or undeformed austenitic phase during the heating step. Preferably a cold working rate of 40% or more, further preferably 50%, is preferable in order to make appear the superstructure within the reformed or undeformed austenitic phase during the heating step. It has been observed that a cold working rate of 25% does not make it possible to obtain this superstructure, regardless of the duration of the heating step.

Preferably, a nitrogen concentration of the reformed austenitic phase of the non-magnetic part obtained by the method is lower than the nitrogen concentration of the mechanical part.

Preferably, a nitrogen concentration of the deformed austenitic phase is higher than that of the reformed austenitic phase. Further preferably, the nitrogen concentration of the deformed austenitic phase is equal to or approximately equal to the nitrogen concentration of the mechanical part.

Preferably, the method results in nitrogen depletion in the austenitic phase of the mechanical part located in the zones adjacent to the dislocations, preferably and in particular at the sliding bands.

Preferably, the method results in the precipitation of nitrides.

Preferably, the nitride precipitates and the nitrogen depletion of the austenitic phase of the mechanical part are generated during the heating step.

Austenitic alloy, preferably according to the invention, obtained or likely to be obtained by the method according to the invention.

The alloy according to the invention and/or the non-magnetic part according to the invention is preferably implemented by the method according to the invention. Preferably, the method according to the invention is particularly adapted, further preferably specially designed, to implement the alloy according to the invention and/or the non-magnetic part according to the invention. Thus, any characteristic of the method according to the invention can be integrated into the alloy according to the invention and/or into the non-magnetic part according to the invention and vice versa.

### DESCRIPTION OF THE FIGURES

Further advantages and features of the invention will become apparent upon reading the detailed description of non-limiting implementations and embodiments, and the following appended drawings:

FIG. 1 shows scanning electron microscopy images of a balance staff,

FIG. 2 is a diagram illustrating the hardness of bars made of 20AP and FINEMAC steels before and after implementation of the method for manufacturing hardened precision timepieces in the state of the art for an applied load of 0.5 kg,

FIG. 3 illustrates the course of the induced moment in an annealed 316L steel part 513, in a cold worked 316L steel part 511, in an annealed nickel-free alloy A1 514 and in a cold worked nickel-free alloy A1 512 as a function of the magnetic field applied,

FIG. 4 illustrates a magnification of the curves 511, 512 and 514 of FIG. 3,

FIGS. 5a and 5b are, respectively, scanning electron microscopy images of a bar turned part and of a bar turned and smoothed part,

FIG. 6 is a diagram representing the hardness, for an applied load of 1 kg, of raw bars made of alloys A1 cold worked to a cold working rate of 85% and the hardness 612 of raw bars made of alloys A2 cold worked to a cold working rate of 85% as a function of the heating temperature and for a heating time of one hour,

FIG. 7 illustrates the course of hardness, for an applied load of 1 kg, as a function of the cold working rate of bars comprised of the alloy A1 for different bar heating temperatures.

FIG. 8 illustrates the course of the hardness, for an applied load of 1 kg, of a bar comprised of alloy A1 cold worked to a cold working rate of 85% as a function of the heating time, for a heating temperature of 575° C.,

FIGS. 9a and 9b set forth, respectively, the equivalent hardness HV1 measured at the surface and at different depths in an alloy A1 bar cold worked and then heated to a temperature of 525° C. and respectively in an alloy A1 bar cold worked by drawing and then surface cold worked by machining and then heated to a temperature of 525° C.,

FIG. 10 shows bright-field transmission electron microscopy images and crystallographic analysis of a part manufactured by the method according to the invention,

FIG. 11 is a graph illustrating the course of the hardness of a non-magnetic part, obtained by the method according to the invention, as a function of the cold working rate of the mechanical part, from which the non-magnetic part is obtained, and of the duration of the heating step,

FIG. 12 is a scanning electron microscopy image of a cross-section of a non-magnetic part according to the invention, on which the surface layer and the central portion of the non-magnetic part are visible,

FIG. 13 is a scanning electron microscopy image of a cross-section of the surface portion of a non-magnetic part according to the invention, showing the structure of the surface layer which has been cold worked and then heated,

FIG. 14 is a scanning electron microscopy image in thin-film backscattered electron diffraction mode of a cross-section of the surface portion of a non-magnetic part according to the invention, on which the reformed austenitic domains, the superstructures and the nitride precipitates are visible.

### DESCRIPTION OF THE EMBODIMENTS

As the embodiments described below are by no means limiting, it will be possible especially to consider alternatives to the invention comprising only a selection of the characteristics described, isolated from the other characteristics described (even if this selection is isolated within a sentence comprising these other characteristics), if this selection of characteristics is sufficient to confer a technical advantage or to differentiate the invention from the state of prior art. This selection comprises at least one characteristic, preferably functional without structural details, or with only part of the structural details if this part alone is sufficient to confer a technical advantage or to differentiate the invention from the state of prior art.

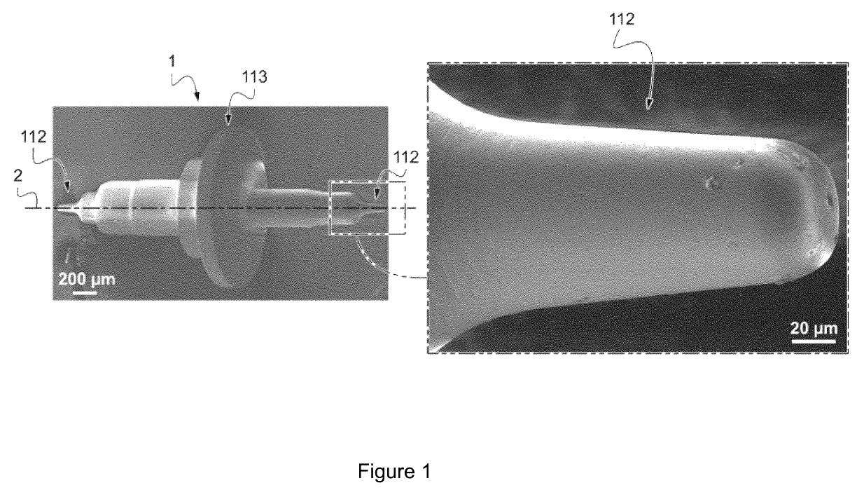

The embodiment set forth is directed to the manufacture of a non-magnetic part of revolution 1. In a non-limiting illustration, the part manufactured may be a clockwork balance wheel 1 or balance staff 1 as represented in FIG. 1. FIG. 1 sets forth an image of a conventional balance wheel 1. A balance wheel 1 is a part of revolution comprising an axis of revolution 2. Each of the two ends 112 of the balance wheel 1 forms a pivot zone 112 for forming a friction zone 112. The diameter of the pivot zones 112, radially measured with respect to the axis of revolution 2, is approximately 60 μm.

For the manufacture of the balance wheel 1 and other precision timepieces that should have particular mechanical properties, in particular good resistance to impact, fracture, deformation and wear, steel with the trade name with the abbreviation DIN 1.1268+Pb is known in the state of the art, comprising, in weight percentage, 1% carbon, 0.4% manganese, 0.2% silicon, sulphur, 0.2% lead, less than 0.03% phosphorus and the balance iron. Steel with the trade name FINEMAC© and the abbreviation DIN 1.1268, which is an alternative to 20AP and which comprises, in weight percentage, 1% carbon, 0.5% manganese, 0.27% silicon, 0.1% sulphur, containing no lead, less than 0.03% phosphorus and the balance iron is also known.

In the state of the art, the usual method for manufacturing the balance wheel 1 and other precision timepieces is known, comprising machining a raw bar made of 20AP or FINEMAC steel, followed by a hardening heat treatment. The hardening heat treatment comprises heating to a temperature above 700° C., typically in the order of 800° C., for 15 minutes followed by water quenching the part followed by tempering at a temperature below 300° C., typically 175° C. for 30 minutes to adjust the hardness and relax the stresses generated during quenching. This hardening heat treatment is followed by a final step of smoothing the part manufactured, for example by roll bending aiming at improving the surface finish of the part.

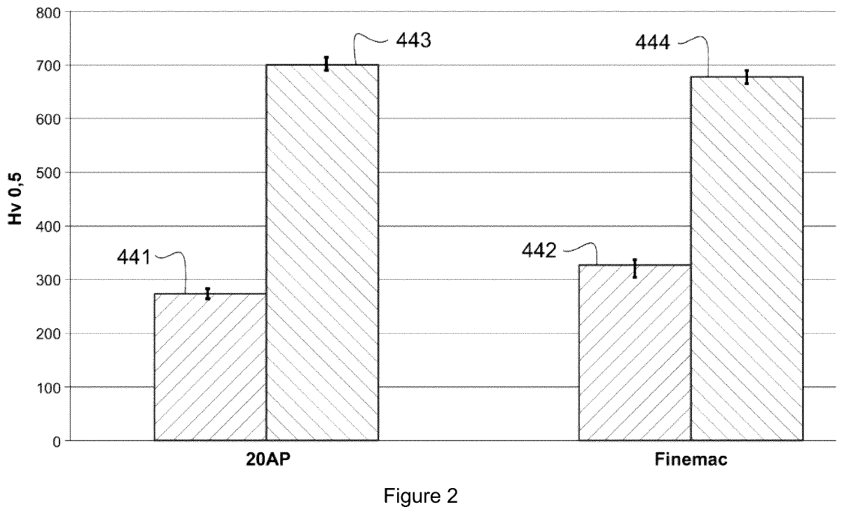

FIG. 2 shows a diagram illustrating the Vickers hardness (HV) measured on 2 mm diameter bars made of 20AP and FINEMAC steels before 441, 442 and after 443, 444 implementing the state-of-the-art hardening heat treatment for an applied load of 0.5 kg. Bars 441 and 442 respectively illustrate hardness of the raw bar of 20AP steel, before implementation of the state of the art hardening heat treatment, and respectively the hardness of the raw bar of FINEMAC steel, before implementation of the hardening heat treatment. These measurements have been obtained from the data (time-temperature) set out in the state of the art. Bars 443 and 444 in FIG. 2 respectively illustrate the hardness of the 20AP steel balance obtained by implementing the hardening heat treatment of the state of the art and the hardness of the FINEMAC steel balance obtained by implementing the hardening heat treatment of the state of the art respectively. The hardness values of the raw bars are in the order of 300 HV_{0.5} and the hardness of the balance wheels is less than or equal to 700 HV_{0.5}.

Alloys of the state of the art have been ruled out due to the excessive residual magnetisation that appears after cold working these alloys. In particular, the current standard stipulates that a watch should not have its chronometric quality degraded when exposed to magnetic fields of 60 Gauss. However, electromagnetic pollution has increased steadily in recent decades and our apparatuses and watches are now constantly exposed to strong magnetic fields, for example a smartphone now emits an average of 80 gauss. There is therefore a need to find an alternative to state-of-the-art alloys.

In the course of this research, the inventors observed that some austenitic alloys can be used, in a counter-intuitive way, when used under the conditions of the method according to the invention, for the manufacture of parts requiring significant machining and/or hardening. Indeed, austenitic alloys are known to be difficult to machine and are therefore not used when extensive machining and/or several machining steps are required. According to the invention, the austenitic alloys chosen to make up the precision timepiece comprise, in weight percentage, iron between 50 and 85%, one or more gammagenic elements whose weight percentage or the sum of the weight percentages is between 8 and 38%.

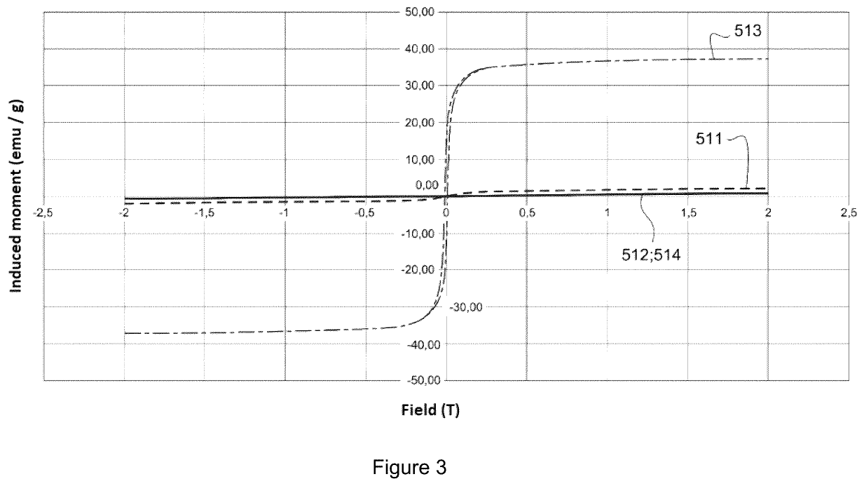

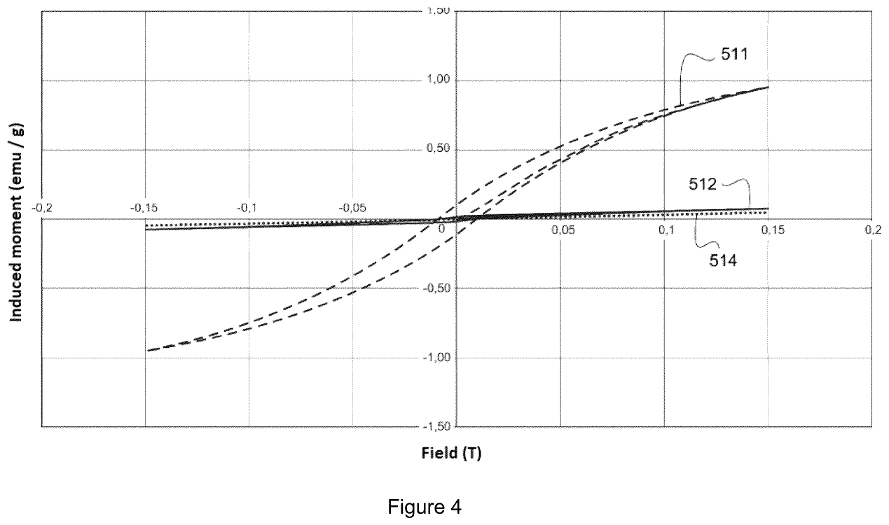

The effect of cold working on the residual magnetisation of an austenitic alloy with the trade name 316L© has been evaluated. This effect is set forth in FIGS. 3 and 4. FIGS. 3 and 4 illustrate the magnetic susceptibility of austenitic alloys, that is the course of the induced magnetic moment in emu/g as a function of the applied field in Tesla, and the residual magnetisation of these austenitic alloys. The 316L alloy comprises, in weight percentage, between 16 and 19% chromium, between 9 and 13% nickel, between 1.5 and 3% molybdenum, less than 2% molybdenum, less than 0.01% manganese, less than 0.03% carbon, less than 0.005% sulphur, less than 0.003% nitrogen, less than 0.002% oxygen and the balance iron. FIGS. 3 and 4 illustrate the course of the induced magnetic field of 316L after annealing 511 at a temperature of 1050° C. for 30 minutes and of drawn 316L 513 at a cold working rate of 60%. The relative permeability, noted μᵣ, of 316L after drawing 513 at a cold working rate of 60% is 8.8 and the relative permeability of 316L after annealing 511 at a temperature of 1050° C. for 30 minutes is 1.08. It is noticed that the value of the residual magnetisation is greater than ten emu/g for cold worked 316L 513. These residual magnetisation values are incompatible with applications in the watchmaking field and do not allow this type of alloy to be used as a non-magnetic part and, in particular, as a precision timepiece.

According to the invention, austenitic alloys are used, counter-intuitively and surprisingly, when implemented under the conditions of the method, to manufacture parts with good mechanical properties, in particular good resistance to impact, fracture, deformation and wear. Indeed, it is known that the hardening heat treatments of the state of the art detailed above (heating to a temperature above 750° C. followed by quenching and tempering) are not effective on austenitic alloys.

It is known in the state of the art that the mechanical properties of iron-based alloys, in particular good resistance to impact, fracture, deformation and wear, are conferred by the presence of nickel in the alloy. According to the invention, the inventors have observed, surprisingly and counter-intuitively, that austenitic alloys not comprising nickel can be used for the manufacture of parts which need to have good mechanical properties when they comprise nitrogen in a weight percentage greater than 0.1% and less than 2% and when they are used under the conditions of the method according to the invention.

In accordance with a non-limiting embodiment set forth, two particular alloys have been chosen to study effect of the method and to study the alloy and part manufactured by the method according to the invention: an austenitic alloy, referred to as A1, comprising, in weight percentage, between 0.15 and carbon, between 9.5 and 12.5% manganese, 16.5% chromium, between 0.45 and 0.55% nitrogen, 2.7% molybdenum and the balance iron and an austenitic alloy, referred to as A2, comprising between 21 and 24% manganese, between 19 and 23% chromium, between 0.5 and 1.5% molybdenum, 0.9% nitrogen, less than 0.08% carbon and the balance iron. The method according to the invention does not cause any significant change in the composition of the alloy making up the mechanical part or the raw bar used for implementing the method. Consequently, the precision timepiece obtained by implementing the method according to the invention comprises the same composition as that of the alloy making up the mechanical part or the raw bar used (A1 and A2 according to the non-limiting embodiment set forth).

The effect of cold working on the residual magnetisation of the A1 and 316L alloys is set forth in FIGS. 3 and 4. Curves 512 and 514 represent the respective course of the magnetic moment induced in the alloy A1 after annealing at a temperature of 1050° C. for 30 minutes and drawing at a cold working rate of 72%. The relative permeability, μᵣ, of the alloy A1 after drawing at a cold working rate of 72% is 1.006 and the relative permeability, μᵣ of the alloy A1 after annealing at a temperature of 1050° C. for 30 minutes is 1.002. It is noticed in FIG. 4 that the residual magnetisation values for the annealed A1 512 alloy and the cold worked A1 514 alloy are less than 1·10⁻² emu/g. These residual magnetisation values, μᵣ equal to 1.006 and 1.002, are better than those obtained with the 316L alloy, μᵣ equal to 8.8 and 1.08, and make the austenitic alloys according to the invention good candidates for use as non-magnetic parts and, in particular, as precision timepieces.

In accordance with a preferred but non-limiting embodiment of the invention, the method comprises a step of obtaining a mechanical part, at least one portion of a surface of which has a hardness greater than 350 HV. The mechanical part is a part of revolution, in particular a solid rod. The obtaining step is followed by a surface cold working step aiming at forming a surface layer radially extending from the surface of the mechanical part towards the axis of rotation (and symmetry) of the mechanical part. The surface layer is typically less than 30 μm thick. The surface layer exhibits a cold working rate gradient along the direction radially extending from the surface of the cold worked mechanical part inwardly of the cold worked mechanical part. The variation in cold working rate along the thickness of the superficial layer is greater than 18%. In other words, the difference between the cold working rate of the surface of the mechanical part and the cold working rate of the central portion of the mechanical part is greater than 18%. Furthermore, the cold working rate of the surface of the cold worked mechanical part, obtained by implementing the surface cold working step, is greater than 100%. The surface cold working step is followed by a step of heating the cold worked mechanical part to a temperature of between 350° C. and 700° C. to harden the cold worked parts of the mechanical part.

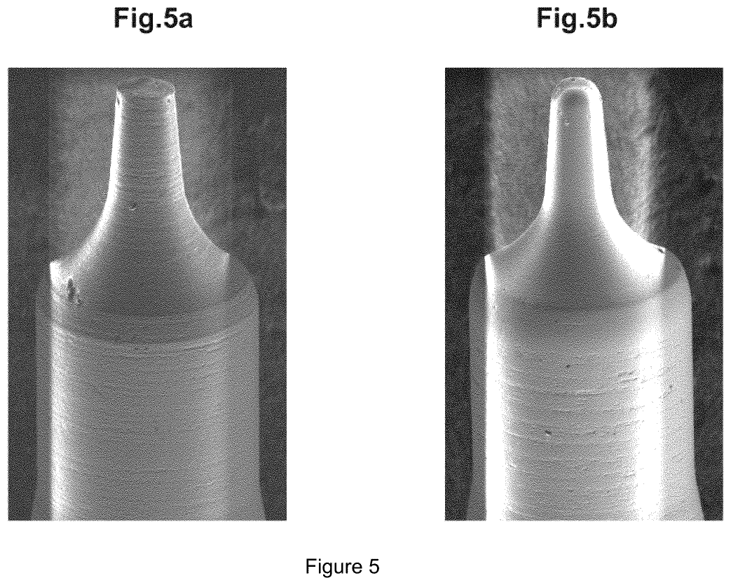

According to the non-limiting embodiment set forth, the surface cold working step is a turning step which, in addition to surface cold working the mechanical part, has the effect of decreasing roughness of the surface of the mechanical part. FIG. 5b is an image of one end of the raw bar turned, then surface cold worked and simultaneously smoothed by roll bending, which is a particular turning method. The centre line average roughness of the cold worked and smoothed mechanical part obtained is in the order of 0.05 μm.

According to the non-limiting embodiment set forth, the obtaining step of the method comprises manufacturing the mechanical part from a raw bar made of alloy A1 or A2. The obtaining step comprises a step of cold working at least one portion of the raw bar followed by a step of bar turning at least one portion of the cold worked raw bar. The purpose of this cold working step is to increase density of dislocations in the cold worked raw bar, and therefore in the mechanical part. The cold worked raw bar is referred to as the turning bar, and the turned bar, that is the raw bar cold worked and then turned, corresponds to the mechanical part. A bar turned end of the raw bar is set forth in FIG. 5a. The raw bar has the form of a wire (or tube or rod) 2 to 4 mm in diameter, typically 3 mm, and has a hardness in the order of 280 HV. It is worth noting that the raw bar, or the cold worked raw bar, should not have too high a cold working rate, typically less than 50%, for bar turning to be carried out correctly.

According to the non-limiting embodiment set forth, the raw bar. The cold working step is a drawing step aiming at increasing the hardness of the raw bar. The effect of the cold working step, in this case drawing, is to cold work the raw bar to a cold working rate greater than 30%.

According to the non-limiting embodiment set forth, the bar turning step is carried out in such a way as to obtain the particular shape of the balance staff 1 as represented in FIG. 1. In particular, the bar turning step is intended to obtain a turned bar with a diameter ranging from 20 to 60 μm at the ends 112, corresponding to the pivot zones 112 of the balance wheel 1, and 1.4 mm for the part 113 of the raw bar that has been cold worked and turned and having the largest diameter. The bar turning step further cold works the turning bar (the bar obtained after the drawing step) and substantially modifies the cross-section of the bar turned. Thus, the mechanical part (cold worked and turned bar) has a cross-section that varies along its axis 2 of revolution.

According to the non-limiting embodiment set forth, the heating step is implemented for a duration of one hour at a temperature below 700° C. with a temperature rise ramp of 50° C./min under ambient conditions. The method according to the invention makes it possible to obtain mechanical properties similar or even better than those obtained by state-of-the-art hardening heat treatments, while eliminating the quenching step required in state-of-the-art hardening heat treatments. The fact that this heating step according to the invention is carried out at low temperature, in particular compared with the temperatures of the state-of-the-art hardening heat treatments, means that there is no stress concentration in the part after the heating step according to the invention. The method according to the invention therefore does not require tempering after the heating step.

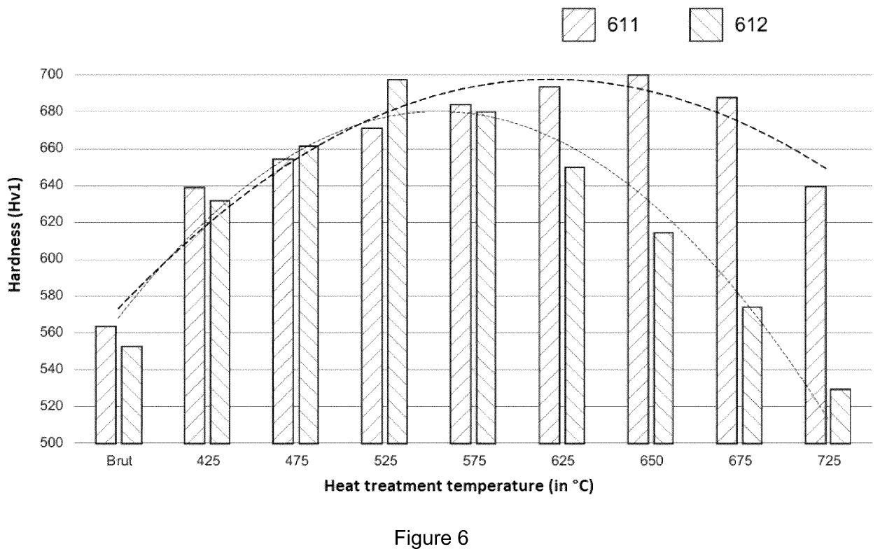

With reference to FIG. 6, the effect of heating on the hardening of alloy A1 and A2 raw bars cold worked by drawing at a rate of 85% is illustrated. FIG. 6 is a diagram in which the hardness 611 of alloy A1 raw bars cold worked at a cold working rate of 85% and the hardness 612 of alloy A2 raw bars cold worked at a cold working rate of 85% is set forth as a function of the heating temperature. The heating time is one hour. A decrease in the effect of heating on hardness 611 and 612 is observed above 520° C. for the alloy A2 and above 650° C. for the alloy A1. It is also noticed that the preferred temperature is between 450° C. and 640° C. and that the optimum temperature is between 500° C. and 600° C.

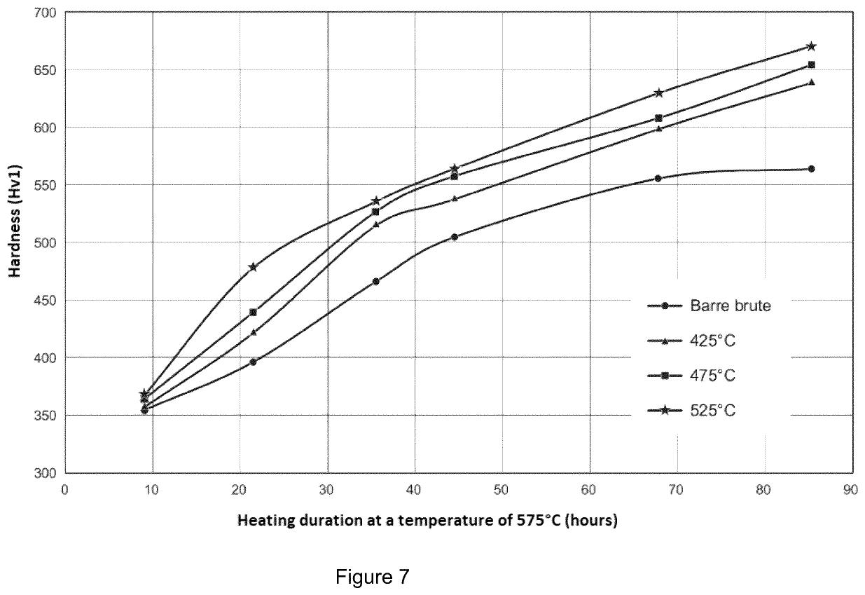

With reference to FIG. 7, the effect of the cold working rate on the hardness obtained after heating is illustrated. FIG. 7 represents the course of the hardness as a function of the cold working rate of a bar with a diameter of 3 mm made of alloy A2 for different heating temperatures. The heating time is one hour. The cold working has been carried out by drawing a raw (not cold worked) bar of alloy A1. It is noticed that the higher the cold working level of the bar before heating, the greater the hardening of the cold worked bar. Consequently, to obtain the highest possible hardness in the mechanical part, it is appropriate to cold work the part as much as possible before implementing the heating step, that is heating a part has the highest possible cold working rate. Furthermore, this also implies that the heating step should preferably be implemented as the last step of the method.

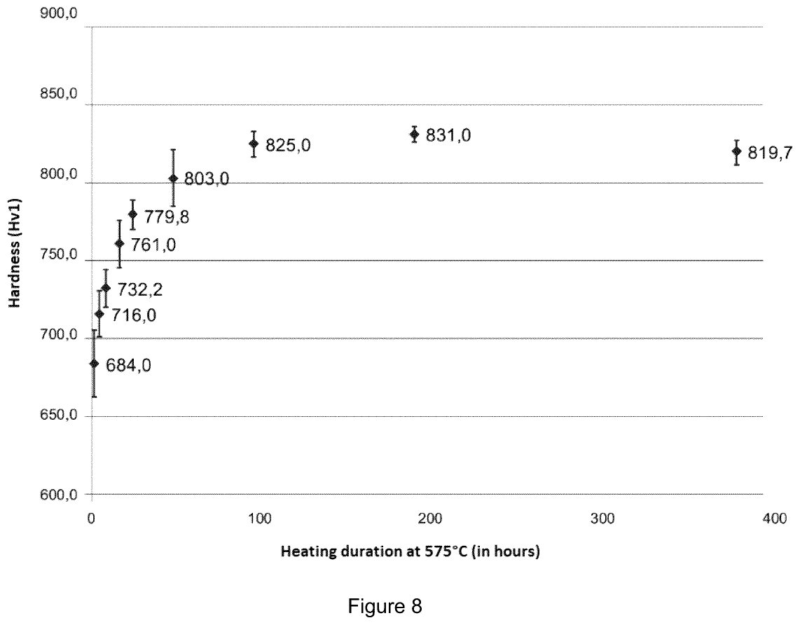

With reference to FIG. 8, the course of the hardness HV1 of an alloy A1 composite bar cold worked to a cold working rate of 85% is illustrated as a function of the heating time for an applied load of 1 kg. The bar is heated to a temperature of 575° C. It is noticed that the hardness is highest for times between 100 and 300 hours. The hardness is greater than 800 HV after 45 hours of heating and 700 HV after 3 hours of heating. The hardness obtained is a function of the cold working rate of the bar before heating and the hardness of the bar before heating. For a given temperature and heating time, the higher the cold working of the bar before heating, the higher the hardness of the bar obtained after heating. Similarly, for a given temperature and heating time, the higher the hardness of the bar before heating, the higher the hardness of the bar obtained after heating.

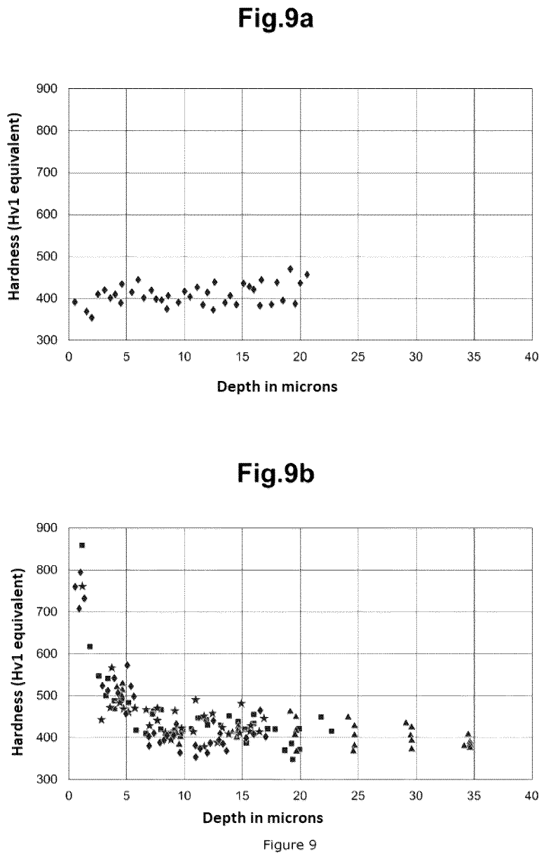

FIGS. 9a and 9b illustrate the course of the hardness of alloy A2 bars as a function of the hardness measurement depth. The measurement depth corresponds to the distance measured radially from the outer surface of the bars towards the axis of rotation (or centre) of the bar. The hardness indicated is an equivalent HV1 hardness, that is for a load of 1 kg, calculated from ultranonindentation hardness measurements with an indentation size in the order of 1.5 μm.

FIG. 9a illustrates the course of the hardness of an alloy A2 raw bar cold worked to a 30% rate by drawing and then heated to a temperature of 525° C. for 1 hour. It is noticed that the hardness of the bar is constant and homogeneous over the entire depth explored. The hardness of the bar is approximately 600 HV1.

FIG. 9b sets forth several series of measurements carried out on an alloy A1 bar cold worked to a 30% rate by drawing, then surface cold worked by machining and then heated to a temperature of 525° C. for 1 hour. After heating the bar, it is noticed that the cold worked and heated part comprises a surface layer having a hardness gradient which decreases along the direction radially extending from the external surface of the part towards the central portion of the part. According to the non-limiting embodiment set forth, the surface layer has a thickness of less than 20 μm, the hardness of the surface of the cold worked and heated part is greater than 700 HV1, the central portion has a hardness less than or equal to 400 HV1 and the hardness gradient in the surface layer is greater than 200 HV1. This demonstrates that surface cold working, when followed by heating according to the invention, makes it possible to obtain a surface layer that has a hardness gradient. It also demonstrates that surface cold working generates an average cold working rate gradient in the surface layer that is greater than 18%. The average cold working rate of the central portion is identical to that of the bar not surface cold worked (by machining), that is less than or equal to 85%, it is in the order of 30% according to the embodiment. The average surface cold working rate is greater than 85%. The machining parameters are not optimal and more effective surface cold working can be achieved.

The fact that the part manufactured according to the method has such a hardness gradient means that the surface hardness of the part is much higher than the hardness of the central portion of the part. The method therefore makes it possible to obtain a part whose central portion retains some ductility and therefore gives the part better resistance to impact, fracture and deformation than a part with a uniform and constant hardness throughout the part.

Furthermore, the method according to the invention makes it possible to modulate hardness of the central portion of the manufactured part according to the application by modulating the cold working rate of the mechanical part resulting from the obtaining step. It is therefore possible to give the part better resistance to impact, fracture and deformation by having a central portion that is more ductile than the surface of the part.

Furthermore, it is possible to provide for the step of obtaining the mechanical part to include cold working of the part as a whole, for example by drawing, at a high cold working rate, for example greater than or equal to 85%, to further increase the hardness of the manufactured part.

The method also makes it possible to obtain a part with very good surface hardness and therefore better resistance to impact and wear.

Furthermore, when the surface cold working step is carried out using a turning operation to smooth and surface cold work the part, in particular roll bending or roller burnishing, this saves considerable time and energy. In addition, using turning to carry out the surface cold working step also makes it possible to take advantage of the cold working of the part generated by smoothing to further increase the hardness of the part after heating.

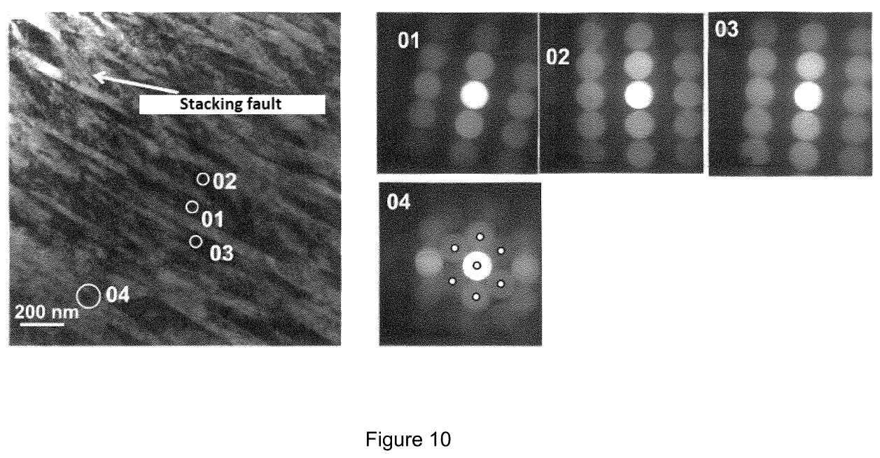

A bright field transmission electron microscopy analysis has been carried out on the parts manufactured by the method according to the invention. With reference to FIG. 10, it has been identified that the manufactured part comprises a predominantly face-centred cubic crystal structure and furthermore comprises the presence of a hexagonal close-packed crystal structure, whereas the A1 and alloys A2 making up the roll bent mechanical part, prior to heating, comprised a single face-centred cubic crystal structure. In particular, this hexagonal close-packed crystallographic structure corresponds to the crystal structure of crystal precipitates, within the face-centred cubic structure, whose Feret diameter is typically between 5 and 80 nm. It therefore appears that the heating step carried out under the conditions of the method according to the invention induces a change in the crystal structure of at least some of the grains of the austenitic alloy making up the mechanical part from a face-centred cubic structure to a hexagonal close-packed structure. The advantages and effects of the alloy according to the invention, particularly with regard to mechanical properties, are, at least in part, conferred by the observed modifications in crystallographic structure.

The inventors have also observed the presence of nitrogen atoms surrounding the dislocations of the austenitic alloy making up the part manufactured by the method according to the invention. The advantages and effects of the alloy according to the invention, in particular relating to the mechanical properties, are, at least in part, conferred by the decreased mobility of the dislocations in the part manufactured due to the presence of nitrogen atoms about the dislocations.

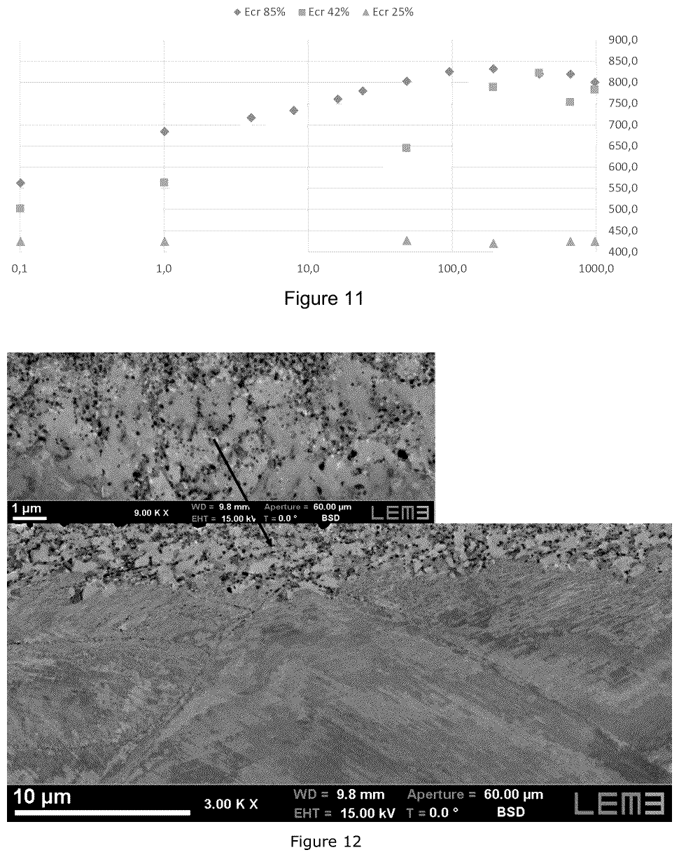

The results set forth in FIGS. 11 to 14 have been obtained from non-magnetic parts obtained according to the method described in the invention. The mechanical parts used to obtain the non-magnetic parts are 3.2 mm diameter bars made of an alloy found under the trade names CHRONIFER® 108 and BIODUR® 108. CHRONIFER® 108 UNS S29108 is sold by KLEIN company. CHRONIFER® 108 consists, in weight percentage, of manganese between 21 and 24%, chromium between 19 and 23%, molybdenum between 0.5 and 1.5%, nitrogen at 0.9%, copper at 0.25%, carbon at a weight percentage of less than 0.08%, silicon at a weight percentage of less than 0.75, phosphorus at a weight percentage less than 0.03%, sulphur less at a weight percentage than 0.1%, nickel at a weight percentage less than 0.1% and iron, the weight percentage of which completes the composition to yield a total of 100%. The BIODUR® 108 alloy is sold by CARPENTER. BIODUR® 108 consists, in weight percentage, of manganese between 21 and 24%, chromium between 19 and 23%, molybdenum between 0.5 and 1.5%, 0.9% nitrogen, 0.01% sulphur, copper, 0.1% nickel, 0.75% silicon, 0.08% carbon, 0.03% phosphorus and iron, the weight percentage of which completes the composition to yield a total of 100%. Identical results have been obtained for each of the CHRONIFER® 108 and BIODUR® 108 alloys.

FIG. 11 illustrates the course of the hardness HV1 of a non-magnetic part obtained by using the method according to the invention. The abscissa axis shows the duration of the heating step in hours and the ordinate axis shows the hardness HV1 of the magnetic part obtained. The heating step is carried out at 575° C. FIG. 11 illustrates the effect of the cold working rate of the mechanical part and the effect of the heating time on the hardness of the non-magnetic part obtained. Three cold working rates have been studied: 25%, 42% and 85%. It is noticed that the higher the cold working rate of the mechanical part, the greater the hardness of the resulting mechanical part.

The cold working step generates dislocations. These dislocations form intra- and inter-granular nucleation sites for nitride precipitates. Furthermore, these dislocations accelerate the precipitation of nitride precipitates during the heating step. The dislocations therefore contribute to increasing the hardening of the alloy.

Furthermore, according to the invention, cold working prior to heat treatment makes it possible to obtain precipitation at temperatures necessarily below 700° C., preferably at temperatures of 650° C. or less. Usually, this precipitation is observed at temperatures well above 700° C. Furthermore, cold working prior to heat treatment makes it possible to obtain substantial precipitation for shorter heating times.

Furthermore, it has been observed that for a cold working rate of 42% and a heating time of 48 hours at 575° C., the ratio of the volume of deformed austenitic phase to the volume of reformed austenitic phase is in the order of 50%. It has also been observed that for a cold working rate of 85% and a heating time of 978 h at 575° C., the ratio of the volume of deformed austenitic phase to the volume of reformed austenitic phase is 0%. This shows that under such conditions there is no longer any cold worked austenitic phase.

Furthermore, it has been observed that for a heating time of one hour at 575° C., significant hardening of the part is already measurable. This is due, in particular, to the precipitation of nitrides and the presence of reformed austenite.

In FIG. 12, the surface layer and the central portion of the non-magnetic part is observed. These two portions are clearly visible and distinguishable. The presence of chromium nitride precipitates within the reformed austenite domains is also observed therein. The method according to the invention thus makes it possible to obtain a non-magnetic part with a ductile central portion and a hard superficial layer.

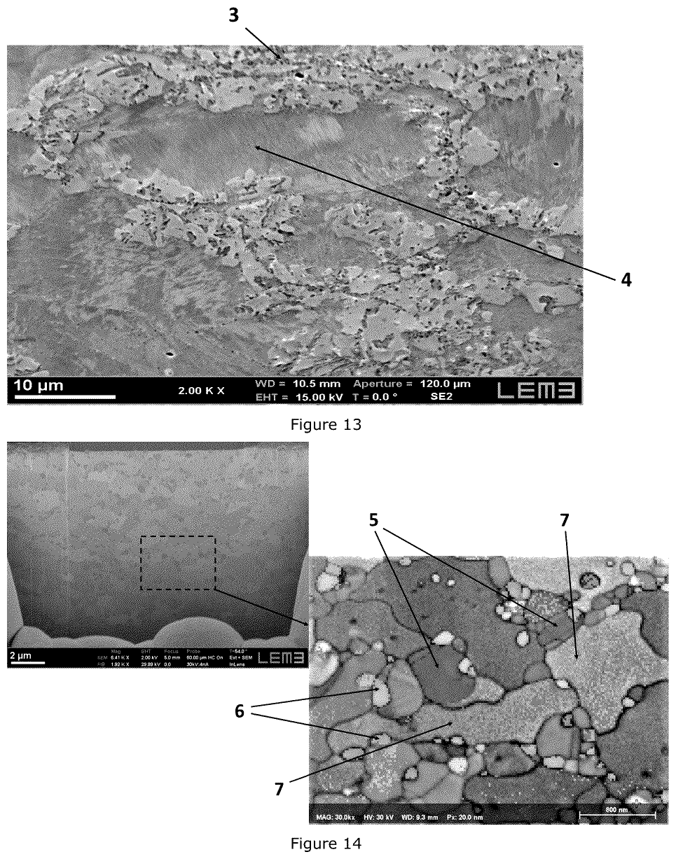

FIG. 13 illustrates the reformed austenitic domains 3, comprising the γ′ and γ″ phases, and the deformed austenitic domains 4, comprising the γ phase.

FIG. 14 illustrates the microstructure of the non-magnetic part obtained by the method according to the invention with cold working at a cold working rate of 85% followed by heating at 575° C. for 978 hours. Reformed domains 5, of the γ′ phase, having a depleted nitrogen concentration, typically less than compared with the nitrogen composition of the mechanical part, can be observed. The presence of precipitates 6 of Cr₂N_{0.91} nitrides can also be observed. Finally, the presence of superstructures 7 of the γ″ phase is also noticed.

It is also observed that the alloy grains have a size smaller than 1 μm. It is also noticed that the size of the nitride precipitates 7 is less than 100 nm.

Of course, the invention is not limited to the examples just described and many alterations can be made to these examples without departing from the scope of the invention.

Thus, in combinable alternatives to the previously described embodiments:
the step of obtaining the mechanical part comprises:
   a step of bar turning at least one portion of the turning bar or at least one portion of the raw bar to form the mechanical part, or
   a step of cold working at least one portion of the raw bar or at least one portion of the turning bar to form the mechanical part, and/or
the non-magnetic part is a precision timepiece, and/or
the non-magnetic part is a pallet staff or an escape pinion, and/or
the invention provides for a use of the non-magnetic part for its non-magnetic and/or hardness and/or tribological and/or fracture resistance properties, and/or
the obtaining step comprises a step of bar turning at least one portion of a turning bar followed by a step of cold working the at least one turned portion of the turning bar to form the mechanical part,
the smoothing step is a roll bending or roller burnishing step, and/or
the austenitic alloy comprises chromium in a weight percentage greater than 8%, and/or
the austenitic alloy comprises nitrogen in a weight percentage greater than and/or
the gammagenic element(s) of the austenitic alloy comprise(s), in weight percentage, manganese between 8 and 30% and/or cobalt between 0 and 10%,
the austenitic alloy comprises one or more non-gammagenic elements, the weight percentage or sum of the weight percentages of which is between 10 and 35%,
the non-gammagenic element(s) of the austenitic alloy comprise(s), in weight percentage, chromium between 0 and 35% and/or molybdenum between 0 and 8% and/or silicon between 0 and 2% and/or titanium between 0 and X and/or niobium between 0 and X % and/or tungsten between 0 and X % and/or sulphur between 0 and 1.5%, and/or
the heating step:
   is implemented for a duration between 10 minutes and 400 hours, and/or comprises a temperature gradient of between 4° C./min and 400° C./min, and/or
   is implemented under a controlled atmosphere, and/or
the hardness gradient has a value greater than or equal to 100 HV, and/or
the turning step is a roll bending or roller burnishing step.

Furthermore, the different characteristics, forms, alternatives and embodiments of the invention may be associated with one another according to various combinations insofar as they are not incompatible or exclusive of one another.

1. A non-magnetic part comprising an austenitic alloy, said austenitic alloy comprising, in weight percentage, iron between 50 and 85%, one or more gammagenic elements whose weight percentage or the sum of the weight percentages is between 15 and 35% and nitrogen at a weight percentage between 0.1% and 2%;
said austenitic alloy has a crystallographic structure comprising a majority cubic crystal structure and a presence of a hexagonal crystal structure; and
the non-magnetic part comprises a hardness gradient along the direction radially extending from the surface of at least one portion of the non-magnetic part inwardly of the non-magnetic part, said hardness gradient having a value greater than or equal to 100 HV where HV is Vickers hardness.

2. The non-magnetic part according to claim 1, wherein at least one portion of a surface of the non-magnetic part has a hardness greater than or equal to 700 HV.

3. The non-magnetic part according to claim 1, wherein the surface layer radially extends from the at least one portion of the surface inwardly of the non-magnetic part over a distance, referred to as the surface layer thickness, of less than 30 μm.

4. The non-magnetic part according to claim 1, comprising a central portion extending from the surface layer inwardly of the non-magnetic part, said central portion having a hardness less than or equal to 600 HV.

5. The non-magnetic part according to claim 1, wherein the non-magnetic part is a precision timepiece.

6. The non-magnetic part according to claim 5, wherein the timepiece is a balance wheel, a pallet staff or an escape pinion.

7. A use of the non-magnetic part according to claim 1, for its non-magnetic and/or hardness and/or tribological and/or fracture resistance and/or resilience properties.

8. A method for manufacturing a non-magnetic part according to claim 1, said method comprising:
a step of obtaining a mechanical part, at least one portion of a surface of the mechanical part having a hardness greater than 350 HV where HV is the Vickers
hardness;
a surface cold working step to form a surface layer radially extending from the at least one portion of the surface of the mechanical part inwardly of the mechanical part; the surface layer comprises a cold working rate gradient, along the direction radially extending from a surface of at least one portion of the non-magnetic part inwardly of the non-magnetic part, having a value greater than 14%; and
a step of heating the at least one portion of the surface of the cold worked mechanical part to a temperature of between 350° C. and 700° C. to harden the cold worked portion or portions of the mechanical part; the surface layer, after heating, has a hardness gradient, along the direction radially extending from the surface of the at least one portion of the non-magnetic part inwardly of the non-magnetic part, having a value greater than or equal to 100 HV.

9. The method according to claim 8, wherein the heating step:
is implemented for a duration of between 10 minutes and 400 hours, and/or
comprises a temperature gradient of between 4° C./min and 400° C./min, and/or
is implemented under ambient conditions.

10. The method according to claim 8, wherein the step of obtaining the mechanical part comprises:
a step of bar turning at least one portion of a turning bar to form the mechanical part, or
a step of cold working at least one portion of a raw bar to form the mechanical part.

11. The method according to claim 8, wherein the step of obtaining the mechanical part comprises:
a step of bar turning at least one portion of a turning bar followed by a step of cold working the at least one turned portion of the turning bar to form the mechanical part, or
a step of cold working at least one portion of a raw bar followed by a step of bar turning at least one portion of the cold worked raw bar to form the mechanical part.

12. The method according to claim 10, wherein the step of cold working the at least one portion of the raw bar or the at least one portion of the turning bar or the at least one turned portion of the turning bar is a drawing step to decrease a diameter of the at least one portion of the raw bar or of the at least one portion of the turning bar or of the at least one turned portion of the turning bar.

13. The method according to claim 8, comprising a smoothing step to decrease a roughness of the at least one portion of the surface of the mechanical part.

14. The method according to claim 13, wherein the smoothing step and the surface cold working step are carried out simultaneously in a single step.

15. The method according to claim 13, wherein the surface cold working step and the smoothing step are a roll bending or roller burnishing.
